(19) United States
(12) Patent Application Publication
(10) Pub. No.: US 2011/0016933 A1
(43) Pub. Date: Jan. 27, 2011

(54) PIVOT LEVER WHICH IS LOCKABLE IN A TROUGH AND HAS A LOCK COVER

(75) Inventors: Dieter Ramsauer, Schwelm (DE); Sebastian Koch, Wuppertal (DE); Andreas Langenberg, Wuppertal (DE)

Correspondence Address: FROMMER LAWRENCE & HAUG, 745 FIFTH AVENUE- 10TH FL., NEW YORK, NY, 10151, US

(73) Assignee: Dirak Dieter Ramsauer Konstruktionselemente GmbH

(21) Appl. No.: 12/671,670

(22) PCT Filed: Jun. 5, 2008
(86) PCT No.: PCT/EP08/04472

§ 371 Date: Mar. 17, 2010

(30) Foreign Application Priority Data
Aug. 2, 2007 (DE) 20 2007 010 804.4

(51) Int. Cl. E05B 47/00; E05B 35/00

(52) U.S. Cl. 70/277; 70/336

(57) ABSTRACT

A swivel lever can be locked in a trough in a swiveled in position and comprises a locking device which is accommodated in the swivel lever and which can be unlocked by way of an access opening in the swivel lever. The access opening can be made inaccessible by means of a cover. The cover can be blocked mechanically, particularly electromechanically, in its covering position.

### TECHNICAL FIELD

The invention is directed to a swivel lever which can be locked in a trough in a swiveled in position and which comprises a locking device which is accommodated in the swivel lever and which can be unlocked by way of an access opening in the swivel lever, which access opening can be made inaccessible by means of a cover.

### PRIOR ART

A swivel lever of the type mentioned above is already known, for example, from DE 10 2004 013 369 A1. Reference is had in particular to FIGS. 5A to 5C. It has turned out that this lock is frequently damaged as a result of vandalism, e.g., by spraying in an instant glue or tampering with the lock in some other manner.

### OBJECT OF THE INVENTION

Therefore, it is the object of the invention to prevent unauthorized persons from moving the cover out of its covering position.

### SUMMARY OF THE INVENTION

The above-stated object is met in that the cover can be blocked mechanically, particularly electromechanically, in its covering position.

Access to the swivel lever lock is at least made more difficult in that the cover can be blocked in its covering position either mechanically or electromechanically.

This reduces the risk of interference with the opening device by unauthorized persons or due to vandalism.

According to a further development of the invention, the cover can be swiveled out of the covering position around an axis extending perpendicular to the extension of the lever. This arrangement is known, per se, from various references. However, the cover cannot be blocked in these arrangements, although devices may be provided which hold the cover in a frictional position or snap in position that defeats unwanted opening.

According to a further development of the invention, the cover can be slid out of the covering position around an axis extending parallel to the lever extension. A solution of this kind is found in the prior art (see component part 132 in FIGS. 5A, 5B and 5C).

According to another alternative, the cover can be folded away around an axis extending perpendicular to the lever extension and parallel to the fastening plane of the lock.

According to a further development of the invention, the cover is blocked by means of a displaceably supported pin or slide. Alternatively, the cover can be blocked by means of a swivelably supported lever.

The cover can be moved against spring force out of the blocking position or (alternatively) out of the releasing position, which facilitates handling.

Accordingly, the cover can be blocked by means of a lock which is actuated by a lifting magnet or solenoid. Alternatively, the cover may be blocked by means of a motor-actuated lock.

According to another embodiment form, the cover is provided for a lock which can be actuated by inserting a key.

On the other hand, the cover can be provided for a profile (half-)cylinder.

The electromechanical drive (e.g., solenoid or motor) can also be provided in a lock case of a bar lock. However, it is also possible to arrange the electromechanical drive in the area of the swivel lever lock.

The electromechanical drive (e.g., solenoid or motor) can also be arranged in the lock case of a bar lock.

It is advantageous when the electromechanical drive can be controlled by a sensor device such as a keypad, a sensing device for biological features (fingerprint, iris, voice, or the like), a code card with magnetic strips, or a chip, or the like.

It is advantageous when the electromechanical drive is part of a monitoring network.

### BRIEF DESCRIPTION OF THE DRAWINGS

The invention will be explained more fully in the following with reference to embodiment examples which are shown in the drawings.

The drawings show:

FIG. 1 a switch cabinet with a swivel lever device constructed according to the invention;

FIG. 2 a rear view of the door leaf of the cabinet arrangement according to FIG. 1 illustrating the invention in connection with a bar lock;

FIG. 3 an alternative embodiment form with the cover in the blocked position in a view similar to that shown in FIG. 2;

FIG. 4 the embodiment form from FIG. 3, but in the released position;

FIG. 5 the lock from FIG. 1 with the cover swiveled away;

FIG. 6 the lock from FIG. 1, but with the cover swiveled away and with the hand lever swiveled; and

FIG. 7 another embodiment form.

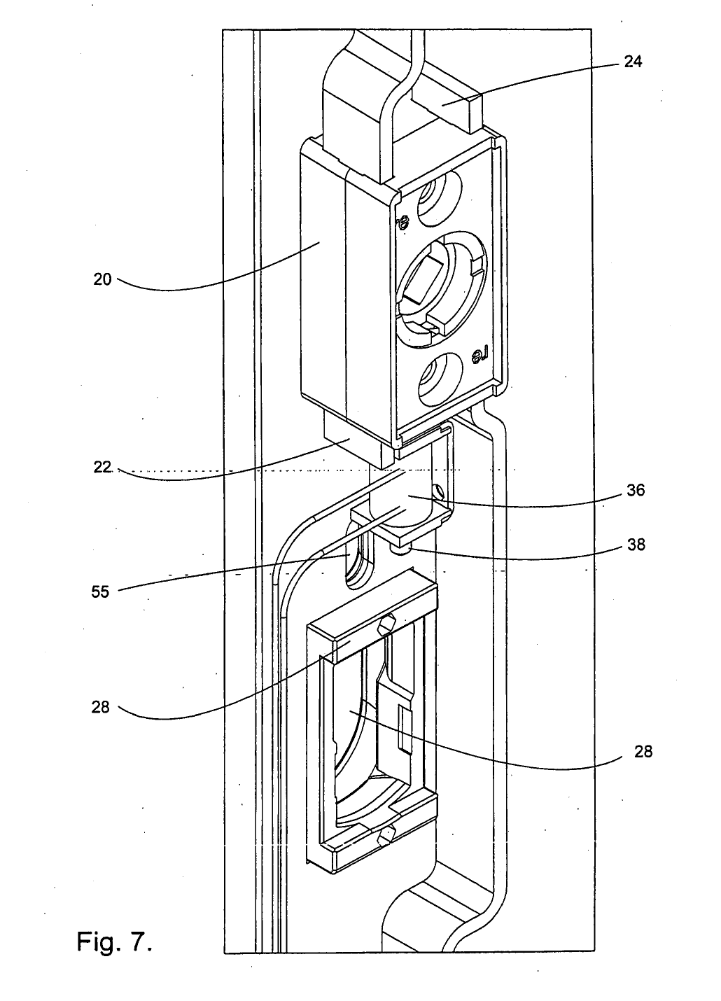

### DETAILED DESCRIPTION OF THE INVENTION

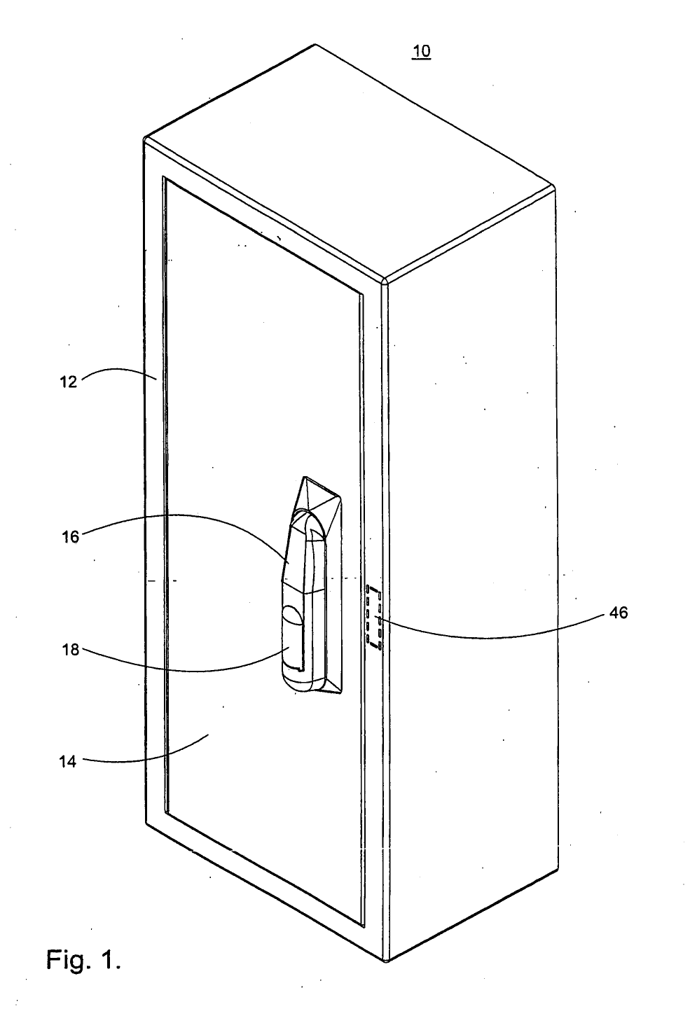

FIG. 1 shows a switch cabinet 10 comprising a frame 12, a door 14 and a swivel lever 16. A swivel lever actuating device 16 is shown on the door leaf 14. This swivel lever actuating device 16 can be locked in the position in which it is swiveled into the trough in a manner which is not shown in more detail. The opening for access to the lock is closed by a cover 18.

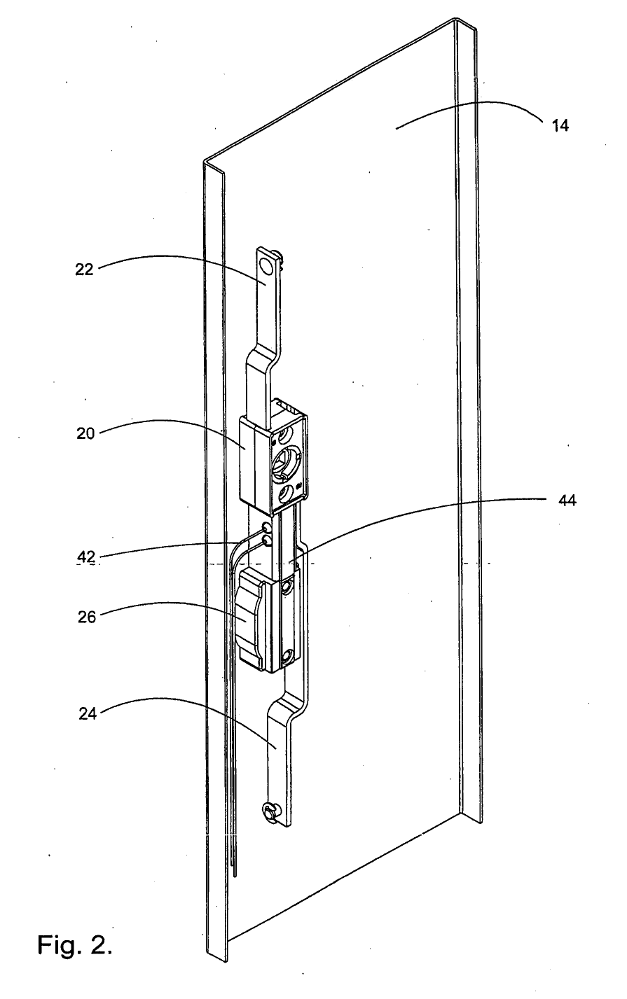

The back of the door leaf 14 (see FIG. 2) shows that the swivel lever drive 16 shown in FIG. 1 communicates with the lock case 20 for pushing the locking bars 22, 24 in and out to open or close the locks, not shown.

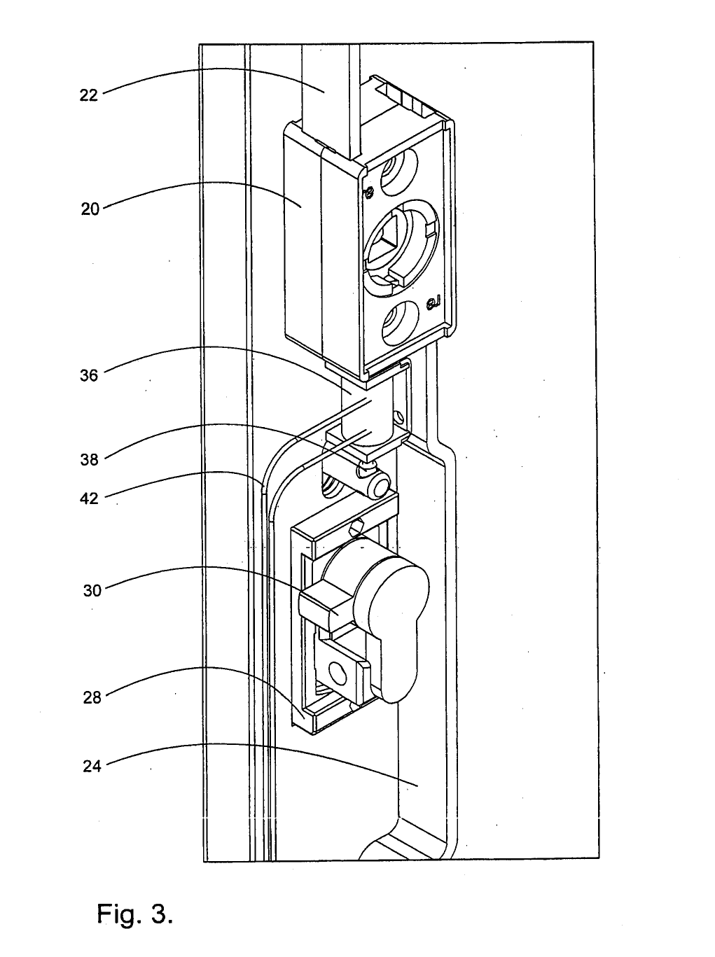

FIG. 2 shows a locking device which in the embodiment form not shown in FIG. 2 comprises a cylinder lock with a cam 30 (see FIG. 3). It can also be seen from FIG. 3 that the cam 30 extends into a trough shoulder 28 so that the swivel lever can no longer be folded out, i.e., the swivel lever is locked.

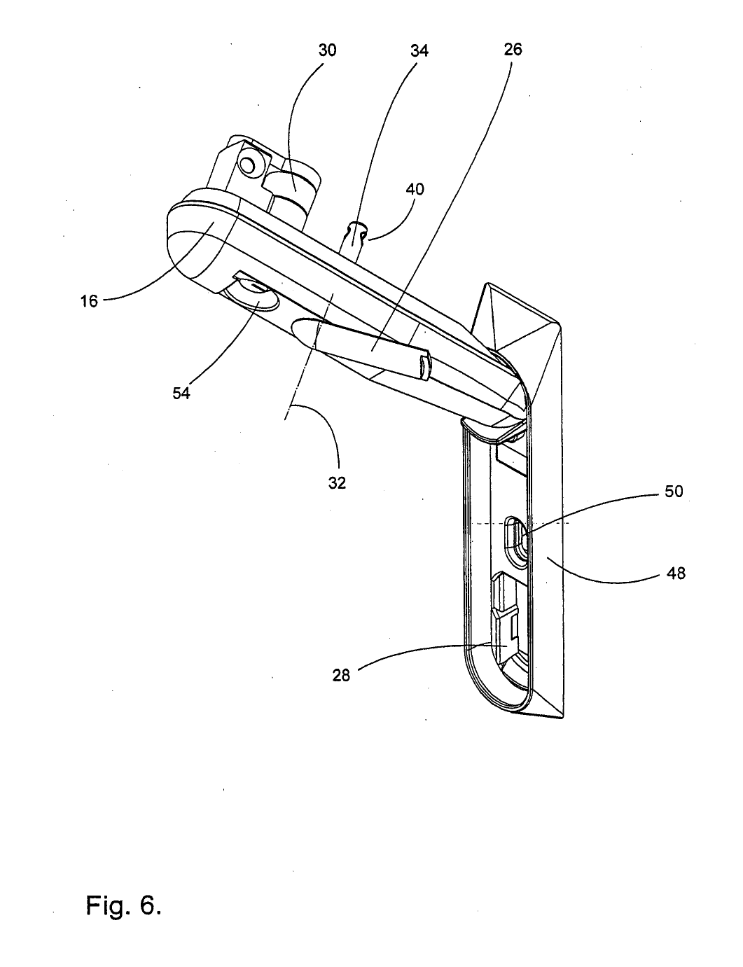

In the embodiment form shown here, the cover 18 can be swiveled away (see FIG. 6) out of the covering position around an axis 32 extending perpendicular to the door leaf plane. In so doing, a shaft piece 34 rotates. If this rotating movement is prevented, the cover cap 26 can no longer be swiveled around the axis 32 and is blocked, for example, in the covering position as is shown in FIG. 1.

This blocking is achieved by means of a pin 38 shown in FIG. 2. This pin 38 penetrates into a bore hole 40 at the end of the shaft 34 so that the shaft can no longer be rotated, i.e., when the pin is located in the position shown in FIG. 3, the cover 18 lies in the covering position according to FIG. 1 and cannot be rotated out of this position. As soon as the solenoid 36 is supplied with current via the connection lines 42 (or, alternatively, when the current is interrupted), the pin 38 is pulled out of the bore hole 40 and the cover 18 is accordingly released so that it can be rotated out of the covered position, for example, into the position shown in FIG. 6.

The inward and outward movement of the pin 38 when the solenoid 36 is actuated can be carried out against spring force in such a way that the rotating movement and, e.g., the movement of the pin 38 into the bore hole 40 is carried out automatically when rotating into the covering position.

The solenoid 36 and the shaft piece 34 with the bore hole 38 can be enclosed by a housing (see reference number 44 in FIG. 2).

An electronic device 46 can serve to trigger the current (or, alternatively to interrupt the current) in the solenoid and accordingly to release the cover 18. This electronic device 46 can be arranged at a suitable location and remote of the locking lever 16. In the present case, it is arranged next to the lock 16 at the door frame of the frame 12. The electronic device 46 can comprise sensor devices which, for example, detect a fingerprint or the color of the iris, or a chip card or a transponder device which identifies a person.

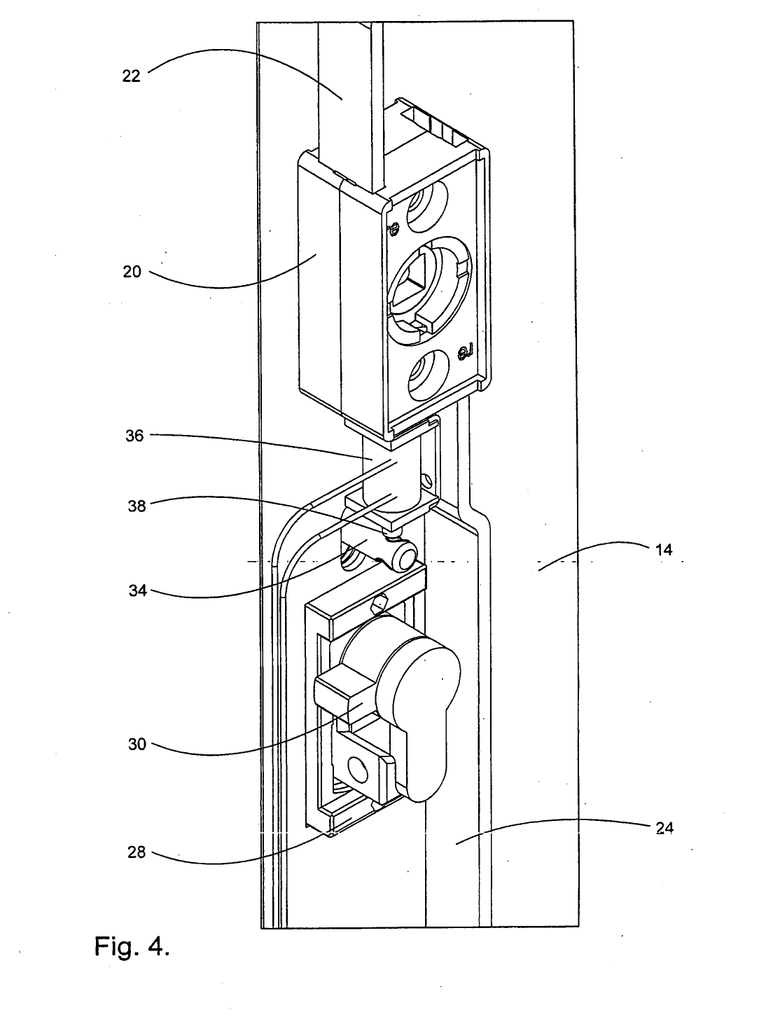

FIG. 3 shows the state with the pin 38 blocking the shaft piece 34, while FIG. 4 shows the state in which the pin is lifted and the shaft piece is released.

FIG. 6 clearly shows the trough 48 with a bore hole 50 which extends through the opening 50 receiving the shaft piece 34. The trough has the shoulder 28, which extends through the corresponding rectangular opening of the door and is held by the latter, and a second fastening position by means of the lock case.

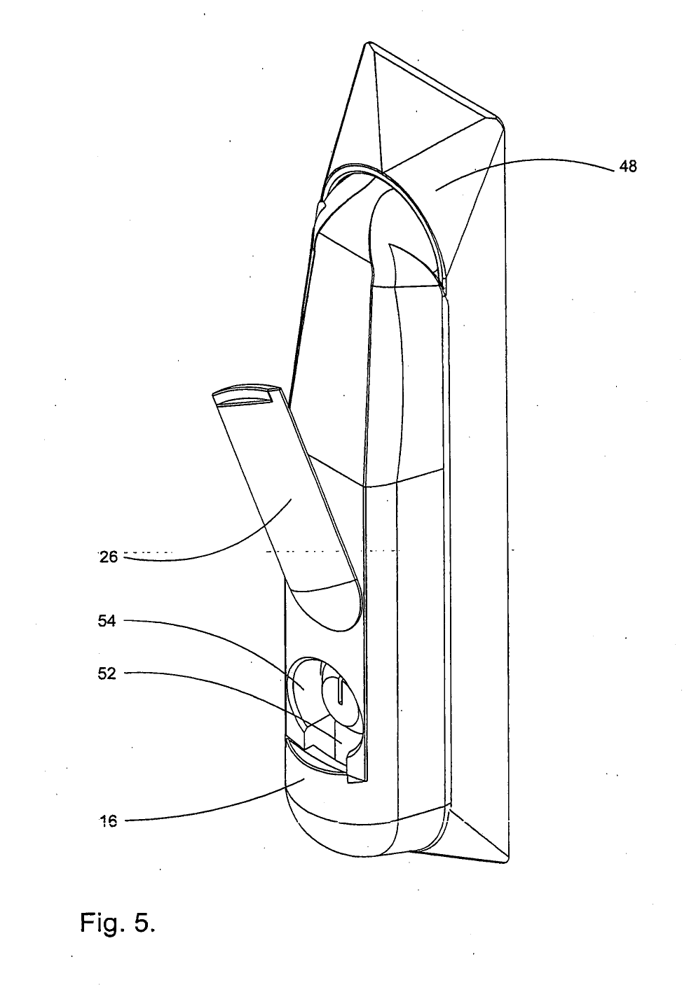

FIG. 5 shows a profile cylinder 52. It clearly shows that the swivel lever actuating device can serve not only as a drive for a bar lock, but also for other types of locks, for example, a rotary sash-type fastener. As such, the embodiment form shown in the drawing is only an example. It is likewise clear that the cylinder can be provided for another type of lock of the lever in the trough, for example, a key lock, not shown. In every case, it is important that a cover 26 is provided for the access to the unlocking of the hand lever 16.

The element, such as the pin 38, blocking the shaft piece can also take other forms to which the shaft piece would then be adapted. For example, the pin could have a rectangular or square cross section, or could have the shape of a fork which engages the shaft piece, in this case, e.g., a rectangular shaft piece, so as to be fixed with respect to rotation relative to it.

The assembly could be configured in such a way that the blocking of the cover is canceled in emergency situations such as a power outage, e.g., in that the pin or the fork is retracted by spring force and the cover is released so that the swivel lever can be unlocked with the appropriate key and folded out so that, for example, a bar lock can be unlocked by turning the swivel lever and, e.g., the cabinet can be opened. Therefore, in case of a power outage, the double safeguard becomes a single safeguard which is sufficient for general protection in most cases of application.

### INDUSTRIAL APPLICABILITY

The invention is industrially applicable in switch cabinet construction.

### REFERENCE NUMBERS

10 switch cabinet
12 frame
14 door
16 swivel lever actuating device
18 cover
20 lock case
22 locking bar
24 locking bar
26 protective cap
28 trough shoulder
30 cam
32 axis
34 shaft piece
36 solenoid, electromagnetic drive
38 pin
40 bore hole
42 connection line
44 housing
46 electronic device, sensor device
48 trough
50 opening
52 profile cylinder
54 access opening

1. A swivel lever which can be locked in a trough in a swiveled in position and which comprises:
a locking device which is accommodated in the swivel lever and which can be unlocked by way of an access opening in the swivel lever; wherein the access opening can be made inaccessible by means of a cover; and
wherein the cover has a blocking means which is accommodated in the swivel lever and which has an electromechanical drive.

2. The lockable swivel lever according to claim 1;
wherein the cover can be swiveled out of the covering position around an axis extending perpendicular to the extension of the lever.

3. The lockable swivel lever according to claim 1;
wherein the cover can be slid out of the covering position around an axis extending parallel to the extension of the lever.

4. The lockable swivel lever according to claim 1; wherein the cover can be folded away around an axis extending perpendicular to the extension of the lever and parallel to a fastening plane of the trough.

5. The lockable swivel lever according to claim 1;
wherein the blocking means of the cover is a displaceably supported pin or slide.

6. The lockable swivel lever according to claim 1;
wherein the blocking means of the cover is a swivelably supported lever.

7. The lockable swivel lever according to claim 1;
wherein the cover can be moved against spring force or against gravitational force out of the blocking position or out of the releasing position.

8. The lockable swivel lever according to claim 1;
wherein the cover can be blocked or released by means of a solenoid-actuated device.

9. The lockable swivel lever according to claim 1;
wherein the cover can be blocked or released by means of a motor-actuated device.

10. The lockable swivel lever according to claim 1;
wherein the cover is provided for a locking device which can be actuated by inserting a key.

11. The lockable swivel lever according to claim 1:
wherein the cover is provided for a profile cylinder.

12. The lockable swivel lever according to claim 1;
wherein the electromechanical drive is accommodated in a lock case of a bar lock.

13. The lockable swivel lever according to claim 1;
wherein the electromechanical drive is arranged or integrated in the area of the swivel lever.

14. (canceled)

15. The lockable swivel lever according to claim 1;
wherein the electromechanical drive can be controlled by a sensor device.

16. The lockable swivel lever according to claim 1;
wherein the electromechanical drive is part of a monitoring network.
